(19) United States
(12) Patent Application Publication
(10) Pub. No.: US 2010/0322526 A1
(43) Pub. Date: Dec. 23, 2010

(54) METHOD OF FILTERING RESTORED IMAGE USING PLURALITY OF FILTERS AND ENCODING/DECODING APPARATUS AND METHOD USING FILTERING METHOD

(75) Inventors: Hahyun LEE, Seoul (KR); Sung-Chang LIM, Daejeon (KR); Hae-Chul CHOI, Daejeon (KR); Se Yoon JEONG, Daejon (KR); Jongho KIM, Busan (KR); Jinho LEE, Daejeon (KR); Hui Yong KIM, Daejeon (KR); Sukhee CHO, Daejeon (KR); Jin Soo CHOI, Daejeon (KR); Jin Woo HONG, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/770,984

(22) Filed: Apr. 30, 2010

(30) Foreign Application Priority Data
Jun. 18, 2009 (KR) 10-2009-0054319
Oct. 29, 2009 (KR) 10-2009-0103599

(51) Int. Cl. G06K 9/36; G06K 9/40

(52) U.S. Cl. 382/232; 382/261

(57) ABSTRACT

A method of filtering a restored image selectively using a plurality of filters, and an encoding and decoding apparatus using the method are provided. The filtering method may filter a restored image using each of a plurality of filter structures to obtain a plurality of filtered restored images, and determine a filter structure of a restored image with a high coding efficiency from among the obtained filtered restored images as a final filter structure.

### CROSS-REFERENCE TO RELATED APPLICATIONS

This application claims priority from Korean Patent Application No. 10-2009-0054319, filed on Jun. 18, 2009, and Korean Patent Application No. 10-2009-0103599, filed on Oct. 29, 2009, in the Korean Intellectual Property Office, the entire disclosures of which are incorporated herein by reference.

### BACKGROUND OF THE INVENTION

1. Field of the Invention

The present invention relates to a method of filtering a restored image selectively using a plurality of filters, and an encoding and decoding apparatus using the method, and more particularly, to a method of filtering a restored image and an encoding and decoding apparatus using the method by selecting an optimum filter from a plurality of filters.

2. Description of Related Art

Currently, research on a method of filtering a restored image by designing an in-loop filter based on a Wiener filter before storing the restored image in a decoded picture buffer, and calculating adaptive filter coefficients for each image has been conducted. In such a method, a central symmetrical structure may be used to reduce an amount of information of encoded filter coefficients. In this instance, since a single filter structure is used, a feature of each image may not be reflected.

### SUMMARY OF THE INVENTION

An aspect of the present invention provides a method of filtering a restored image by selecting an optimum filter from a plurality of filters, and an encoding and decoding apparatus using the method.

According to an aspect of the present invention, there is provided an encoding method, including: filtering a restored image using each of a plurality of filter structures; and determining any one of the plurality of filter structures as a final filter structure using the plurality of filtered restored images.

The plurality of filter structures may include at least one of an adaptive filter structure and a fixed filter structure, and the adaptive filter structure include at least one of a central symmetrical structure, a vertical symmetrical structure, a horizontal symmetrical structure, and a customized symmetrical structure, and the fixed filter structure may indicate a filter structure where filter coefficients is predetermined.

The filtering may include: calculating filter coefficients corresponding to each of the plurality of filter structures, when the plurality of filter structures is an adaptive filter structure; and filtering the restored image using each of the calculated filter coefficients.

The encoding may encode the filter structure information and final filter coefficients corresponding to the determined final filter structure, when the determined final filter structure is an adaptive filter structure, and may encode the filter structure information corresponding to the determined final filter structure, when the determined final filter structure is a fixed filter structure.

According to another aspect of the present invention, there is provided an encoding apparatus, including: a loop filter to filter a restored image using each of a plurality of filter structures, and to determine any one of the plurality of filter structures as a final filter structure using the plurality of filtered restored images; and an entropy encoding unit to encode filter structure information corresponding to the determined final filter structure.

The loop filter may include: a calculation unit to calculate a filter coefficient corresponding to each of the plurality of filter structures, when the plurality of filter structures is an adaptive filter structure; and a determination unit to filter the restored image using each of the calculated filter coefficients, and to determine any one of the plurality of filter structures as the final filter structure, using the plurality of filtered restored images.

When the plurality of filter structures is a fixed filter structure, the loop filter may filter the restored image using each predetermined filter coefficients, and determine any one of the plurality of filter structures as the final filter structure using the plurality of filtered restored images.

According to still another aspect of the present invention, there is provided a decoding method, including: receiving filter structure information encoded for each frame; obtaining a final filter structure, used when encoding is performed, from the received filter structure information; and filtering a restored image to the obtained final filter structure.

The receiving may receive the filter structure information corresponding to the final filter structure and an encoded final filter coefficients corresponding to the final filter structure, when the final filter structure is the adaptive filter structure. The decoding may decode the received final filter coefficients and the received filter structure information, and the filtering may filter the restored image using the final filter structure using the decoded final filter coefficients.

According to yet another aspect of the present invention, there is provided a decoding apparatus, including: an entropy decoding unit to receive filter structure information encoded for each frame; a loop filter to obtain a final filter structure, used when encoding is performed, from the received filter structure information, and to loop-filter a restored image using the obtained final filter structure.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration of an encoding apparatus according to an embodiment of the present invention;

FIG. 2 is a block diagram illustrating a configuration of a loop filter according to an embodiment of the present invention;

FIG. 3 is a flowchart illustrating an encoding method using a plurality of filter structures according to an embodiment of the present invention;

FIG. 4 is a block diagram illustrating a configuration of a decoding apparatus according to an embodiment of the present invention; and

FIG. 5 is a flowchart illustrating a decoding method using a plurality of filter structures according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

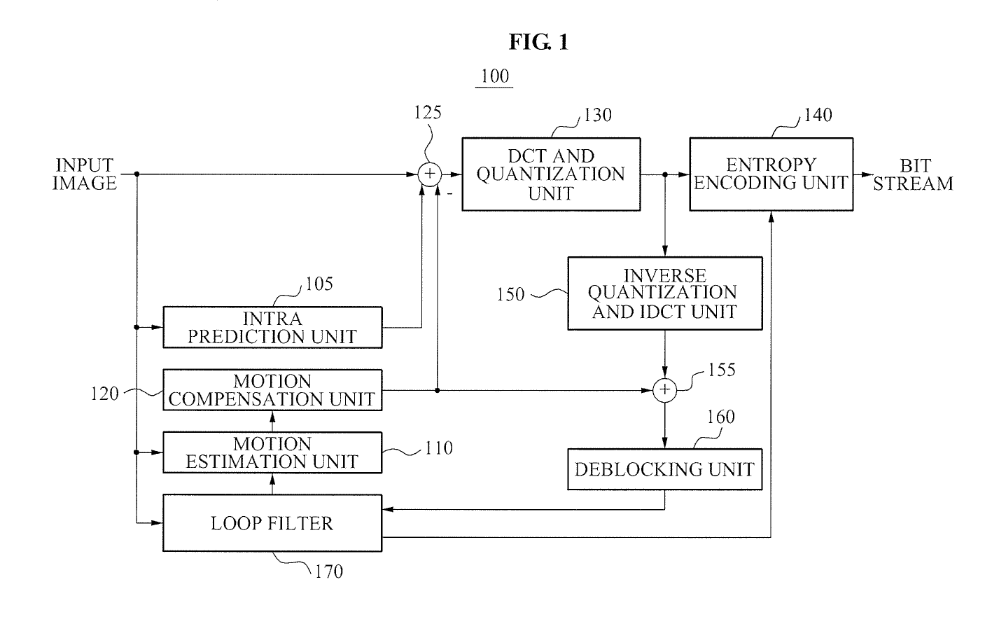

FIG. 1 is a block diagram illustrating a configuration of an encoding apparatus 100 according to an embodiment of the present invention.

Referring to FIG. 1, the encoding apparatus 100 may include an intra prediction unit 105, a motion estimation unit 110, a motion compensation unit 120, a first difference unit 125, a Discrete Cosine Transform (DCT) and quantization unit 130, an entropy encoding unit 140, an inverse quantization and Inverse DCT (IDCT) unit 150, a second difference unit 155, a deblocking unit 160, and a loop-filter 170.

The intra prediction unit 105 may predict a macro block to be encoded and encode the macro block using a pixel value in order to encode a block of a current image. Here, the pixel may be spatially adjacent to the image.

The motion estimation unit 110 may generate a motion vector of a predetermined current block in a current frame, using a reference frame stored in a buffer or a storage unit. Here, the buffer or the storage unit is not illustrated in FIG. 1. Also, the reference frame may be a previous frame sequentially inputted prior to the current frame, or a subsequent frame sequentially inputted after the current frame.

Also, the motion estimation unit 110 may estimate motion using various motion estimation algorithms such as a Block Matching Algorithm (BMA), a Phase Correlation algorithm, a Hierarchical Search BMA (HSBMA), and the like.

The motion compensation unit 120 may generate a prediction block based on the motion vector generated by the motion estimation unit 110. The prediction block may be a prediction value of the current block. The first difference unit 125 may generate a difference block by deducting the prediction block from the current block.

The DCT and quantization unit 130 may perform DCT and quantization with respect to the difference block, generated by the first difference unit 125, and thereby may generate a quantized transform coefficient.

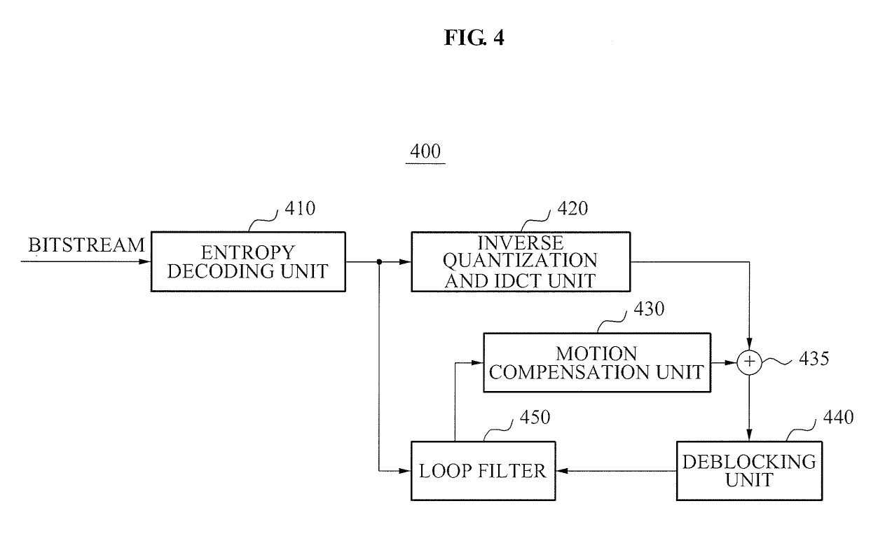

The entropy encoding unit 140 may perform entropy encoding with respect to encoding information, filter structure information, and a final filter coefficient. The encoding information may include the quantized transform coefficient, the motion vector, and the like, and the filter structure information may be received from the loop filter 170. The encoded transform coefficient, the encoded filter structure information, and the encoded final filter coefficients as well as the motion vector may be inserted into a bitstream, and transmitted to a decoding apparatus 400 of FIG. 4.

The inverse quantization and IDCT unit 150 may perform inverse quantization with respect to the difference block, quantized by the DCT and quantization unit 130, to predict a subsequently encoded frame. Also, the inverse quantization and IDCT unit 150 may perform IDCT with respect to the difference block, and thereby may restore the difference block before the encoding is performed.

The second difference unit 155 may restore the current block before the encoding is performed, by adding the restored difference block to the prediction block generated by the motion compensation unit 120.

The deblocking unit 160 may output a restored image by deblock-filtering the current block restored in the second difference unit 155. Accordingly, an error among blocks of the restored image may be reduced and a block boundary of the restored image may be smooth.

The loop filter 170 may filter the restored image, outputted from the deblocking unit 160, using a plurality of filter structures. Here, the plurality of filter structures may include an adaptive filter structure and a fixed filter structure. The adaptive filter structure may include at least one of a central symmetrical structure, a vertical symmetrical structure, a horizontal symmetrical structure, and a customized symmetrical structure. The fixed filter structure may indicate a filter structure where filter coefficients is predetermined, that is, the encoding apparatus 100 or the decoding apparatus 400 may already have information about a filter structure.

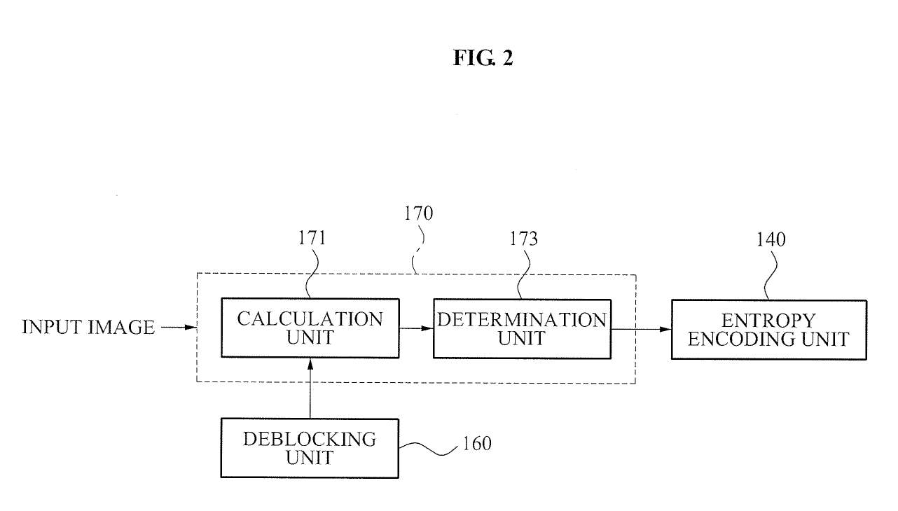

A method of filtering a restored image in the loop filter 170 is described in detail with reference to FIG. 2. A method of loop-filtering the restored image when a plurality of filter structures is an adaptive filter structure is described with reference to FIG. 2.

Referring to FIG. 2, the loop filter 170 may include a calculation unit 171 and a determination unit 173. The loop filter 170 may filter the restored image.

The calculation unit 171 may calculate filter coefficients of each of the plurality of predetermined filter structures. That is, the calculation unit 171 may calculate central symmetrical filter coefficients, vertical symmetrical filter coefficients, horizontal symmetrical filter coefficients, and customized symmetrical filter coefficients. Here, the calculating of the filter coefficients based on the filter structure is not described in detail since it is well-known to those skilled in the related art.

The determination unit 173 may filter the restored image, inputted from the deblocking unit 160, using the filter coefficients calculated by the calculation unit 171. The determination unit 173 may determine a final filter structure using a code rate of each of the filtered restored images. In this instance, the determination unit 173 may determine the final filter structure for each frame by filtering the restored image for each frame.

Specifically, the determination unit 173 may calculate a code rate of each of the plurality of filtered restored images using an original image and each of the plurality of filtered restored images.

That is, the determination unit 173 may filter the restored image using each of the central symmetrical filter coefficients, the vertical symmetrical filter coefficients, the horizontal symmetrical filter coefficients, and the customized symmetrical filter coefficients. Also, the determination unit 173 may calculate the code rate of the restored image filtered to each of the central symmetrical filter structure, the vertical symmetrical filter structure, the horizontal symmetrical filter structure, and the customized symmetrical filter structure. Also, the determination unit 173 may determine a filter structure of a restored image with a high code rate as the final filter structure.

For example, the code rate may be a degradation degree of the restored image. The determination unit 173 may calculate the degradation degree by comparing resolutions of the original image and the restored image. Here, the original image may be a current frame which is an input image before the encoding is performed. Also, the determination unit 173 may determine the final filter structure by applying the filtered restored images and the original image to a rate-distortion optimization scheme according to Equation 1 given as below.

J=min(D+Lamda*(R+R_{Filter})) [Equation 1]

where D, R, and R_{Filter} may denote a distortion of an entire frame, generated bits for residual signal including header information such motion vector, macroblock modes, and generated bits for the filter coefficients and the filter symmetry structure information, respectively.

Also, the determination unit 173 may output the filter structure information and the final filter coefficients to the entropy encoding unit 140. The filter structure information may include the index indicating the final filter structure. In this instance, the determination unit 173 may output the filter structure information of the final filter structure to the entropy encoding unit 140 by setting the filter structure information based on Table 1.

TABLE 1

| Final filter structure | Index |
|---|---|
| Central symmetrical filter structure | 0 |
| Vertical symmetrical filter structure | 1 |
| Horizontal symmetrical filter structure | 2 |
| Customized symmetrical filter structure | 3 |

That is, when the final filter structure is the central symmetrical filter structure, the determination unit 173 may set the filter structure information as ‘0’. When the final filter structure is the vertical symmetrical filter structure, the determination unit 173 may set the filter structure information as ‘1’. When the final filter structure is the horizontal symmetrical filter structure, the determination unit 173 may set the filter structure information as ‘2’. When the final filter structure is the customized symmetrical filter structure, the determination unit 173 may set the filter structure information as ‘3’.

The entropy encoding unit 140 may perform entropy encoding with respect to the final filter coefficients and the filter structure information for each frame, and insert the encoded final filter coefficients and the encoded filter structure information in the bitstream. Also, the entropy encoding unit 140 may transmit the filter coefficients and the filter structure information to the decoding apparatus 400. In this instance, when the final filter structure is the customized symmetrical filter structure, final filter coefficients and filter structure information corresponding to the customized symmetrical filter structure may be entropy-encoded, and be included in a bitstream structure of a Sequence Parameter Set (SPS), a Picture Parameter Set (PPS), a new Network Abstraction Layer (NAL) type, a Supplemental Enhancement Information (SEI) message, or a slice header.

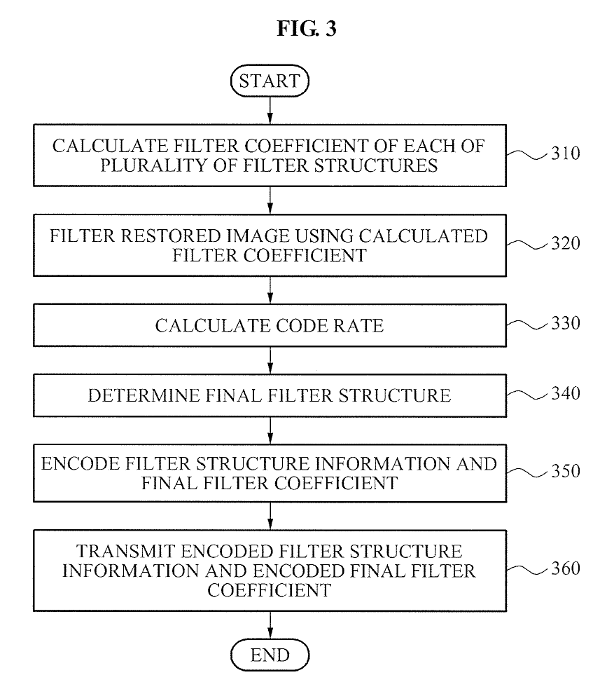

FIG. 3 is a flowchart illustrating an encoding method using a plurality of filter structures according to an embodiment of the present invention. A method of loop-filtering a restored image when the plurality of filter structures is an adaptive filter structure is described with reference to FIG. 3.

In operation 310, the calculation unit 171 may calculate filter coefficients of each of the plurality of filter structures. Here, the plurality of filter structures may include the adaptive filter structure and a fixed filter structure. The adaptive filter structure may include at least one of a central symmetrical structure, a vertical symmetrical structure, a horizontal symmetrical structure, and a customized symmetrical structure, and the fixed filter structure may indicate a filter structure where filter coefficients is predetermined. That is, the encoding apparatus 100 or the decoding apparatus 400 may have information about a filter structure.

In operation 320, the determination unit 173 may filter the restored image using the plurality of calculated filter structures. That is, the determination unit 173 may filter the restored image using central symmetrical filter coefficients, vertical symmetrical filter coefficients, a horizontal symmetrical filter coefficients, and customized symmetrical filter coefficients.

In operation 330, the determination unit 173 may calculate a code rate of each of the filtered restored images.

Specifically, in operation 330, the determination unit 173 may calculate the code rate of each of the plurality of filtered restored images, using an original image and each of the plurality of restored images filtered using the central symmetrical filter coefficients, the vertical symmetrical filter coefficients, the horizontal symmetrical filter coefficients, and the customized symmetrical filter coefficients. For example, the code rate may be a degradation degree of the restored image. The determination unit 173 may calculate the code rate using a variety of well-known schemes of calculating a code rate.

In operation 340, the determination unit 173 may determine a final filter structure using the calculated code rate of each of the plurality of restored images. That is, the determination unit 173 may determine a filter structure and filter coefficients of a restored image with a high code rate as the final filter structure and final filter coefficients. In this instance, the determination unit 173 may set filter structure information based on the final filter structure according to Table 1.

In operation 350, the entropy encoding unit 140 may perform entropy encoding with respect to the final filter coefficients and the filter structure information for each frame. In operation 360, the entropy encoding unit 140 may insert the encoded final filter coefficients and the encoded filter structure information in the bitstream, and transmit the final filter coefficients and the filter structure information to the decoding apparatus 400.

When the final filter structure is the customized symmetrical filter structure, the entropy encoding unit 140 may perform entropy encoding with respect to final filter coefficients and filter structure information corresponding to the customized symmetrical filter structure, and a bitstream structure of an SPS, a PPS, a new NAL type, an SEI message, or a slice header may be included in the bitstream.

Although it has been described that operations of loop-filtering the restored image when the plurality of filter structures is the adaptive filter structure, when the plurality of filter structures is a fixed filter structure, the calculation unit 171 of FIG. 2 may be omitted, and the operation of calculating the filter coefficients in operation 310 may be omitted.

Specifically, when the plurality of filter structures is the fixed filter structure, filter coefficients corresponding to each of the plurality of fixed filter structures is predetermined. Accordingly, the loop filter 170 is not required to calculate the filter coefficients corresponding to each of the plurality of fixed filter structures. Also, the loop filter 170 may loop-filter each restored image using the filter coefficients corresponding to each of the plurality of fixed filter structures, and determine a final filter structure by calculating a code rate of each of the plurality of filtered restored images.

Similarly, when the plurality of filter structures is a combination of an adaptive filter structure and a fixed filter structure, the loop filter 170 may loop-filter a restored image by calculating a filter coefficients corresponding to the adaptive filter structure, and loop-filter the restored image using filter coefficients corresponding to the fixed filter structure. Also, the loop filter 170 may calculate a code rate of each of the filtered restored images, and determine a final filter structure.

In this instance, when the final filter structure is the fixed filter structure, the encoding apparatus 100 may perform entropy encoding with respect to filter structure information corresponding to a final filter structure, and transmit the filter structure information to the decoding apparatus 400. That is, when the final filter structure is the fixed filter structure, the encoding apparatus 100 may not transmit final filter coefficients corresponding to the final filter structure to the decoding apparatus 400.

FIG. 4 is a block diagram illustrating a configuration of the decoding apparatus 400 according to an embodiment of the present invention.

Referring to FIG. 4, the decoding apparatus 400 may include an entropy decoding unit 410, an inverse quantization and IDCT unit 420, a motion compensation unit 430, an adding unit 435, a deblocking unit 440, and a loop filter 450.

The entropy decoding unit 410 may extract a transform coefficient, motion vector, and filter structure information by performing entropy decoding with respect to a bitstream. Also, when final filter coefficients is included in the received bitstream, the entropy decoding unit 410 may extract the final filter coefficients by performing entropy decoding with respect to the bitstream. That is, the entropy decoding unit 410 may decode at least one of the encoded final filter coefficients and encoded filter structure information received from the encoding apparatus 100.

The inverse quantization and IDCT unit 420 may perform inverse quantization with respect to the extracted transform coefficient, and obtain a difference block by performing IDCT.

The motion compensation unit 430 may generate a prediction block of a current block using the motion vector extracted by the entropy decoding unit 410.

The adding unit 435 may add the difference block, obtained by the inverse quantization and IDCT unit 420, to the prediction block, generated by the motion compensation unit 430, and thereby may restore the current block.

The deblocking unit 440 may perform deblocking-filtering with respect to the current block restored by the adding unit 435, and output the restored image.

The loop filter 450 may loop-filter the restored image using at least one of the final filter coefficients and filter structure information extracted by the entropy decoding unit 410. In this instance, the loop filter 450 may determine which filter structure the extracted filter structure information is set from among a plurality of predetermined filter structures, and perform filtering with respect to the restored image.

Specifically, for example, when the filter structure information is set as ‘0’ which indicates a central symmetrical structure which is an adaptive filter structure, the loop filter 450 may filter the restored image using the central symmetrical structure using the final filter coefficients. Here, the central symmetrical structure may indicate a final filter structure determined by the encoding apparatus 100.

Similarly, when the filter structure information is set as the vertical symmetrical structure, the horizontal symmetrical structure, or the customized symmetrical structure, which is the adaptive filter structure, the loop filter 450 may filter the restored image, inputted from the deblocking unit 440, using the vertical symmetrical structure, the horizontal symmetrical structure, or the customized symmetrical structure, using the final filter coefficient extracted by the entropy decoding unit 410. Through this, errors occurring due to the DCT, quantization, and the like, may be reduced, and thus image data, filtered to be similar to an original image, may be outputted.

For example, when the filter structure information is set as an index indicating a fixed filter structure, the loop filter 450 may filter the restored image to the fixed filter structure using filter coefficients corresponding to the fixed filter structure. Here, the fixed filter structure may indicate a final filter structure determined by the encoding apparatus 100, and the filter coefficients corresponding to the fixed filter structure may be a predetermined value that the encoding apparatus 100 and the decoding apparatus 400 already know. Through this, the decoding apparatus 400 may loop-filter the restored image using the filter structure, which is loop-filtered by the encoding apparatus 100, without receiving the final filter coefficients from the encoding apparatus 100.

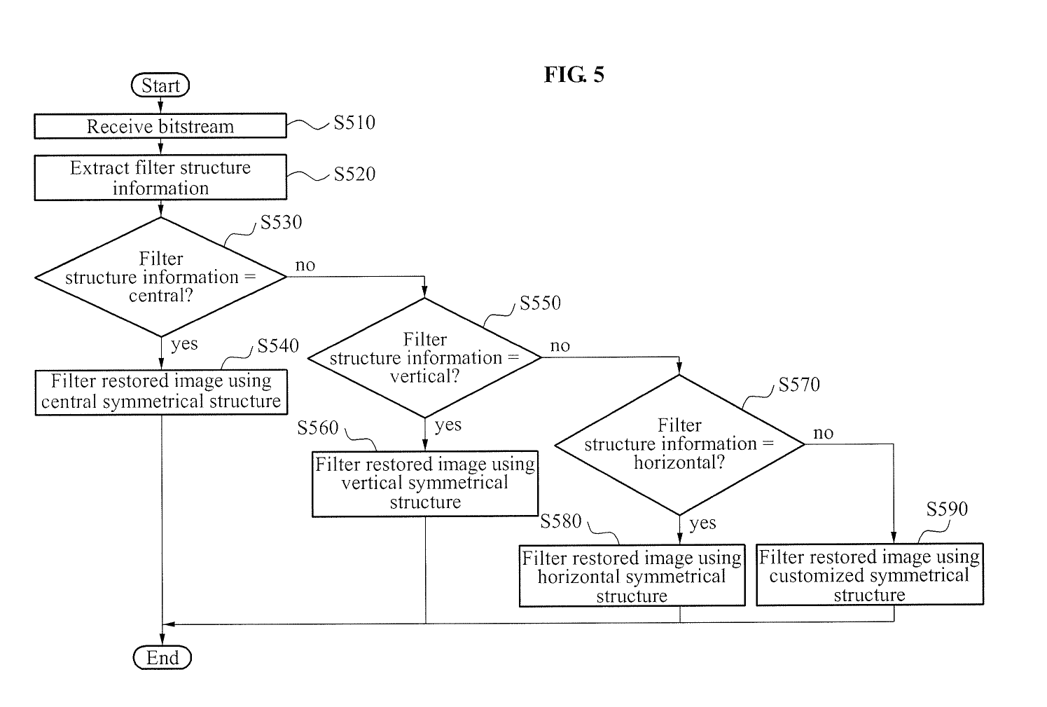

FIG. 5 is a flowchart illustrating a decoding method using a plurality of filter structures according to an embodiment of the present invention. Hereinafter, filter structure information indicating an adaptive filter structure is described as an example.

In operation S510, the entropy decoding unit 410 may receive a bitstream. In operation S520, the entropy decoding unit 410 may perform entropy decoding with respect to the received bitstream, and extract filter structure information. In this instance, when a plurality of final filter coefficients is included in the received bitstream, the entropy decoding unit 410 may perform entropy decoding with respect to the received bitstream, and extract the final filter coefficients.

In operation S530, the loop filter 440 may determine whether the filter structure information is set as a central symmetrical structure. In this instance, when the filter structure information is determined to be set as the central symmetrical structure in operation S530, the loop filter 440 may filter a restored image using the central symmetrical structure using the extracted final filter coefficients in operation S540.

When the filter structure information is not determined to be set as the central symmetrical structure in operation S530, the loop filter 440 may determine whether the filter structure information is set as a vertical symmetrical structure in operation S550.

When the filter structure information is determined to be set as the vertical symmetrical structure in operation S550, the loop filter 440 may filter the restored image using the vertical symmetrical structure using the extracted final filter coefficients in operation S560.

When the filter structure information is not determined to be set as the vertical symmetrical structure in operation S550, the loop filter 440 may determine whether the filter structure information is set as a horizontal symmetrical structure in operation S570.

When the filter structure information is determined to be set as the horizontal symmetrical structure in operation S570, the loop filter 440 may filter the restored image using the horizontal symmetrical structure using the extracted final filter coefficients in operation S580.

When the filter structure information is not determined to be set as the horizontal symmetrical structure in operation S570, the loop filter 440 may filter the restored image using a customized symmetrical structure using the extracted final filter coefficients in operation S590.

Although the filter structure information indicating an adaptive filter structure has been described as an example with reference to FIG. 5, when decoded filter structure information indicates a fixed filter structure, the loop filter 440 may loop-filter the restored image using the fixed filter structure using filter coefficients corresponding to the fixed filter structure. Here, the filter coefficients corresponding to the fixed filter structure is predetermined, and the encoding apparatus 100 and the decoding apparatus 400 may already have information about the predetermined filter coefficients.

Although it has been described that a filter structure, used in the encoding apparatus 100 and decoding apparatus 400 and encoding and decoding method, is a central, vertical, horizontal, and customized symmetrical structure, the filter structure may not be limited to the above-described examples. The filter structure may include at least one of a central, vertical, horizontal, and customized asymmetrical structure.

Also, although a central, vertical, horizontal, and customized symmetrical and asymmetrical filter structure have been described, the encoding apparatus 100 and decoding apparatus 400 and encoding and decoding according to an embodiment of the present invention may determine a final filter structure and final filter coefficients using other filter structures.

Also, although it has been described that an index is predetermined to be as ‘0’ through ‘3’ according to Table 1, the index may not be limited thereto. The index may be predetermined, for example, a bit, octet, byte, and the like, depending on a filter structure supported by the encoding and decoding apparatus.

Also, although it has been described that a degradation degree is calculated by comparing resolutions of a restored image and an original image, the determination unit 173 may determine a final filter structure of a current frame using a previously determined final filter structure of a previous frame. That is, the encoding apparatus 100 and decoding apparatus 400 and encoding and decoding method may determine the final filter structure without using the original image.

Also, although the encoding apparatus 100 and decoding apparatus 400 and encoding and decoding method have been described based on an image, it may be described based on a block which is obtained by dividing an image. That is, each block may determine a filter identically or differently. Accordingly, a plurality of filters may be used with respect to a single image.

Also, although it has been described that a final filter structure is determined after loop-filtering a restored image, the loop filter 170 may determine the final filter structure before loop-filtering the restored image.

That is, the determination unit 173 may determine the final filter structure using a statistical characteristic of a restored image or a distribution of a pixel value.

Through this, the decoding apparatus 400 may obtain the final filter structure of the restored image, which is loop-filtered in the encoding apparatus 100, by inferring the final filter structure from previously decoded images. Here, since a method of inferring is well-known to those skilled in the related art, it is not described in detail.

Also, although it has been described that a filter structure, applied to a restored image with a lowest degradation degree, is determined as a final filter structure, the calculation unit 171 may calculate calculation complexities to loop-filter the restored image using a plurality of filter structures, and the determination unit 173 may determine a filter structure having a lowest calculation complexity from among the calculated calculation complexities.

As described above, the encoding and decoding apparatus may filter the restored image with a lowest degradation degree. Accordingly, the restored image may be filtered and encoded based on characteristics of the image, and a coding efficiency may be improved.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An encoding method, comprising:
filtering a restored image using each of a plurality of filter structures; and
determining any one of the plurality of filter structures as a final filter structure using the plurality of filtered restored images.

2. The encoding method of claim 1, wherein the plurality of filter structures includes at least one of an adaptive filter structure and a fixed filter structure, and the adaptive filter structure includes at least one of a central symmetrical structure, a vertical symmetrical structure, a horizontal symmetrical structure, and a customized symmetrical structure, and the fixed filter structure indicates a filter structure where a plurality of filter coefficients is predetermined.

3. The encoding method of claim 2, wherein the customized symmetrical structure indicates a filter symmetrical structure customized by a user, and is included in a bitstream structure of a Sequence Parameter Set (SPS), a Picture Parameter Set (PPS), a new Network Abstraction Layer (NAL) type, a Supplemental Enhancement Information (SEI) message, or a slice header.

4. The encoding method of claim 1, wherein the filtering comprises:
calculating a plurality of filter coefficients corresponding to each of the plurality of filter structures, when the plurality of filter structures is an adaptive filter structure; and
filtering the restored image using each of the calculated filter coefficients.

5. The encoding method of claim 1, further comprising:
encoding filter structure information corresponding to the determined final filter structure for each frame,
wherein the determining determines the final filter structure for each frame.

6. The encoding method of claim 5, wherein the encoding encodes the filter structure information and final filter coefficients corresponding to the determined final filter structure, when the determined final filter structure is an adaptive filter structure, and
encodes the filter structure information corresponding to the determined final filter structure, when the determined final filter structure is a fixed filter structure.

7. The encoding method of claim 1, wherein the determining calculates a code rate of each of the plurality of filtered restored images, and determines a filter structure of a restored image with a high code rate as the final filter structure.

8. The encoding method of claim 1, wherein the filtering loop-filters the restored image.

9. An encoding apparatus, comprising:
a loop filter to filter a restored image using each of a plurality of filter structures, and to determine any one of the plurality of filter structures as a final filter structure using the plurality of filtered restored images; and
an entropy encoding unit to encode filter structure information corresponding to the determined final filter structure.

10. The encoding apparatus of claim 9, wherein the loop filter comprises:
a calculation unit to calculate filter coefficients corresponding to each of the plurality of filter structures, when the plurality of filter structures is an adaptive filter structure; and
a determination unit to filter the restored image using each of the calculated filter coefficients, and to determine any one of the plurality of filter structures as the final filter structure, using the plurality of filtered restored images.

11. The encoding apparatus of claim 9, wherein, when the plurality of filter structures is a fixed filter structure, the loop filter filters the restored image using each predetermined filter coefficients, and determines any one of the plurality of filter structures as the final filter structure using the plurality of filtered restored images.

12. The encoding apparatus of claim 9, wherein the entropy encoding unit encodes the filter structure information and a final filter coefficient corresponding to the determined final filter structure, when the determined final filter structure is an adaptive filter structure, and
encodes the filter structure information corresponding to the determined final filter structure, when the determined final filter structure is a fixed filter structure.

13. The encoding apparatus of claim 9, wherein the plurality of filter structures includes at least one of an adaptive filter structure and a fixed filter structure,
the adaptive filter structure includes at least one of a central symmetrical structure, a vertical symmetrical structure, a horizontal symmetrical structure, and a customized symmetrical structure, and
the fixed filter structure indicates a filter structure where a plurality of filter coefficients is predetermined.

14. A decoding method, comprising:
receiving filter structure information encoded for each frame;
obtaining a final filter structure, used when encoding is performed, from the received filter structure information; and
filtering a restored image to the obtained final filter structure.

15. The decoding method of claim 14, wherein the filter structure information is an index indicating the final filter structure used when the restored image is filtered,
the final filter structure includes at least one of an adaptive filter structure and a fixed filter structure,
the adaptive filter structure includes at least one of a central symmetrical structure, a vertical symmetrical structure, a horizontal symmetrical structure, and a customized symmetrical structure, and
the fixed filter structure indicates a filter structure where a plurality of filter coefficients is predetermined.

16. The decoding method of claim 15, further comprising:
decoding the received filter structure information,
wherein the filtering loop-filters the restored image using the decoded filter structure information.

17. The decoding method of claim 16, wherein the receiving receives the filter structure information corresponding to the final filter structure and encoded final filter coefficients corresponding to the final filter structure, when the final filter structure is the adaptive filter structure,
the decoding decodes the received final filter coefficients and the received filter structure information, and
the filtering filters the restored image using the final filter structure using the decoded final filter coefficients.

18. A decoding apparatus, comprising:
an entropy decoding unit to receive filter structure information encoded for each frame;
a loop filter to obtain a final filter structure, used when encoding is performed, from the received filter structure information, and to loop-filter a restored image using the obtained final filter structure.

19. The decoding apparatus of claim 18, wherein the entropy decoding unit receives and decodes filter structure information corresponding to the final filter structure and an encoded final filter coefficients corresponding to the final filter structure, when the final filter structure is an adaptive filter structure, and
the loop filter loop-filters the restored image using the final filter structure using the final filter coefficients, when the final filter structure is the adaptive filter structure based on the decoded filter structure information.

20. The decoding apparatus of claim 18, wherein the entropy decoding unit receives and decodes the filter structure information corresponding to the final filter structure, when the final filter structure is a fixed filter structure, and
the loop filter loop-filters the restored image using predetermined filter coefficients corresponding to the fixed filter structure, when the final filter structure is the fixed filter structure.
